(19) United States
(12) Patent Application Publication
(10) Pub. No.: US 2015/0294401 A1
(43) Pub. Date: Oct. 15, 2015

(54) SYSTEMS AND METHODS FOR GENERATING ACTUAL PRICING DATA OF RENTAL PROPERTIES

(71) Applicant: MasterCard International Incorporated, Purchase, NY (US)

(72) Inventors: Debashis Ghosh, Charlotte, NC (US); Randy Shuken, Westport, CT (US); Todd Woodruff, St. Charles, MO (US)

(73) Assignee: MasterCard International Incorporated, Purchase, NY (US)

(21) Appl. No.: 14/249,905

(22) Filed: Apr. 10, 2014

(51) Int. Cl. G06Q 30/06; G06Q 50/16

(52) U.S. Cl. CPC G06Q 30/0645; G06Q 50/163

(57) ABSTRACT

A computer-implemented method for determining actual pricing data for rental properties is described. The method is implemented using a computing device having a processor communicatively coupled to a memory. The method includes receiving rental transaction data from a payment system, wherein the rental transaction data includes a plurality of payment transactions, generating a one or more rental data sets, where each rental data set includes a rent amount paid, a rental location identifier, a payor identifier, and a landlord identifier, generating a list of rental properties based on the rental location identifiers from the one or more rental data sets, determining the rent amounts paid for each rental property from the one or more rental data sets, and generating a rental report based on the list of rental properties and the determined rent amount paid for each rental property.

### BACKGROUND

The field of the disclosure relates generally to determining pricing data for rental properties, and more particularly, to network-based systems and methods for determining the actual pricing data for rental properties based on payment card transaction data and/or check transaction data.

At least some known systems used for determining rental prices of rental properties attempt to determine rental prices based, in part, on advertised rental prices. Similarly, the known system will gather advertised rental prices for advertised rental properties and use these advertised prices as the actual rent amount being paid for said corresponding property. However, there is oftentimes a variance between an advertised rental price and the price that is actually paid by the tenant to the landlord. The actual paid amount takes into account discounts and other incentives that rental property owners offer to renters to move-in or stay in the rental property. Accordingly, these known systems that use advertised rental prices as the actual paid amount fail to provide accurate estimates of rental prices for rental properties.

### BRIEF DESCRIPTION OF THE DISCLOSURE

In one aspect, a computer-implemented method for determining actual pricing data for rental properties is described. The method is implemented using a computing device having a processor communicatively coupled to a memory. The method includes receiving by the processor rental transaction data from a payment system, where the rental transaction data includes a plurality of payment transactions, generating by the processor a one or more rental data sets, wherein each rental data set includes a rent amount paid, a rental location identifier, a payor identifier, and a landlord identifier. The method also includes generating by the processor a list of rental properties based on the rental location identifiers from the one or more rental data sets, determining by the processor the rent amounts paid for each rental property from the one or more rental data sets, and generating by the processor a rental report based on the list of rental properties and the determined rent amount paid for each rental property.

In another aspect, a computing device for determining actual pricing data for rental properties is described. The computing device comprises one or more processors communicatively coupled to one or more memory devices. The computing device is configured to receive rental transaction data from a payment system, wherein the rental transaction data includes a plurality of payment transactions, generate a one or more rental data sets where each rental data set includes a rent amount paid, a rental location identifier, a payor identifier, and a landlord identifier, generate a list of rental properties based on the rental location identifiers from the one or more rental data sets, determine the rent amounts paid for each rental property from the one or more rental data sets, and generate a rental report based on the list of rental properties and the determined rent amount paid for each rental property.

In a further aspect, a computer-readable storage medium having computer-executable instructions embodied thereon is described. When executed by a computing device having at least one processor coupled to at least one memory device, the computer-executable instructions cause the processor to receive rental transaction data from a payment system where the rental transaction data includes a plurality of payment transactions, generate a one or more rental data sets, wherein each rental data set includes a rent amount paid, a rental location identifier, a payor identifier, and a landlord identifier, generate a list of rental properties based on the rental location identifiers from the one or more rental data sets, determine the rent amounts paid for each rental property from the one or more rental data sets, and generate a rental report based on the list of rental properties and the determined rent amount paid for each rental property.

### BRIEF DESCRIPTION OF THE DRAWINGS

FIGS. 1-9 show example embodiments of the methods and systems described herein.

FIG. 1 is a schematic diagram illustrating an example multi-party check processing system for enabling ordinary payment-by-check transactions in which an account holder makes a check payment to a merchant, and the check is drawn to an account issued by an issuing bank.

FIG. 2 is a schematic of a check that may be used in a financial transaction, such as the transaction described in FIG. 1.

FIG. 3 is a schematic diagram illustrating an example multi-party transaction card processing system for enabling ordinary payment-by-card transactions in which merchants and card issuers do not need to have a one-to-one special relationship.

FIG. 4 is a block diagram of an example payment processing system used for determining the actual rent prices paid at different addresses in accordance with one example embodiment of the present disclosure.

FIG. 5 illustrates an example configuration of a client system shown in FIG. 4, in accordance with one embodiment of the present disclosure.

FIG. 6 illustrates an example configuration of the rental property monitoring (RPM) computing device shown in FIG. 4, in accordance with one embodiment of the present disclosure.

FIG. 7 is a simplified block diagram of an example embodiment of the payment processing system for determining which transactions of a plurality of transactions received from the payment card processing system and the check processing system contain rental data.

FIG. 8 is a flowchart of an example process for determining the actual rental prices of rental properties implemented using the payment processing system with the RPM computer device in accordance with one embodiment of the disclosure.

FIG. 9 is a diagram of components of one or more example computing devices that may be used in the system shown in FIG. 4.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

The systems and methods described herein are configured to determine the actual rent prices paid for a plurality of rental properties located at different addresses. Checks, cash, and payment card payments remain the predominant tender for rental payments. By combining check and payment card rental payments actual rental prices can be determined for rental properties. A rental property monitoring (“RPM”) computer device, which is in communication with a payment card network and a check processing network, receives a plurality of transactions from both the payment card network and the check processing network. The transaction data includes at least a payor identifier, the address of the payor, the amount paid, and a payee identifier. In some embodiments, the address of the payor may be the street address of the building, where the building contains multiple units. In other embodiments, the address of the payor may also include the apartment or unit number being rented.

The RPM computer device filters the plurality of transactions received from both the payment card network and the check processing network to determine which transactions are related to payments of rent for rental properties. From the filtered transactions, the RPM computer device determines a rental location identifier for the rental property, a rent amount paid and a landlord identifier. Using the filtered transactions, the RPM computer device generates a transaction list of properties by address. The RPM computer device is configured to determine the rent amount paid for each of the rental properties on the transaction list of properties. The RPM computer device is configured to generate a rental report based on the list of properties and the processed rental amounts. The rental report may include a rent amount paid, a payor identifier, a geographic region of the rental property, a rental location identifier for the rental property, a landlord identifier, an advertised rental amount, an advertised square footage, and a rental period. In some embodiments, the rental report may also provide a range of rental amounts paid for the rental property, a change of rental amounts paid over time for the rental property, a turnover rate for at least one rental property of the plurality of rental properties, rental amounts paid for each of the plurality of rental properties, and a variance between an advertised rental amount and the rental amount paid for the rental property.

The rental report may be segregated by individual apartment or aggregated into a single report for all apartments within a single building street address. In some cases, the rental report may not include transaction data (i.e. rent amount paid, and payor identifier) for each rental unit in a rental property due to a lack of transaction data for that particular unit. Certain rental property buildings may also include multiple different sizes and or styles of units. For these reasons, the rental report may be segregated to show data for individual apartments, for different sizes or styles of apartments, or show ranges of rent amounts paid for those units within a rental property building.

In the example embodiment, the RPM computer device determines that the transaction data is associated with a rental transaction based upon the presence of a rental transaction indicator. As described below, the RPM computer device determines the presence of a rental transaction indicator by scanning the transaction data for the presence of at least one rental transaction indicator. The rental transaction indicator may include any characteristic which can identify a transaction as a rental transaction. Accordingly, as described below, the rental transaction indicator may represent a payee known to be a rental property merchant (e.g., a landlord or a property management service). Alternately, the rental transaction indicator may represent the detection of a fixed, periodic payment with certain numeric characteristics, such as round numbers. For example, if a payor has a recurring, fixed transaction on or near the same approximate day of the month, the transactions may be identified as rental transactions. Upon determining that the transaction data is associated with a rental transaction, the RPM computer device processes the transaction data into a rental data set. A rental data set represents a data set associated with at least one payor for a particular rental property. A rental data set may include, for example and without limitation, the geographic region of the rental property, a rental price, a move-in date to the rental property, a move-out date from the rental property, a record of increases in rental prices, and a categorization of the rental property. The categorization of the rental property may include any categorization of rental property including, for example, apartments, single family houses, multi-family houses, duplexes, and quadplexes. Geographic region may be any geographic identifier including, for example and without limitation, a postal code, a city/town/municipality, a neighborhood in a city/town/municipality, GPS coordinates, a county, a street address, a unit number, and sub-divisions of any of the preceding geographic identifiers.

In some embodiments, a publically available list of rental properties is generated from publically available data, such as city ordinances and rental listings on the Internet. In this embodiment, the RPM computer device compares the advertised addresses from the publically available list of rental properties generated from publically available data with the processed addresses provided in the transaction data. Based on the comparison, the RPM computer device generates the transaction list of rental properties by address.

In some embodiments, RPM computer device also receives rental listing data. Rental listing data represents publically available data for rental property properties such as rental property. Rental property listing data may also include, for example and without limitation, an advertised rental amount, a property tax associated with rental property, an advertised square footage associated with rental property, a physical layout associated with rental property, a number of units rented/available associated with rental property, and service and maintenance records associated with rental property. Rental listing data may be stored in a database accessible to the RPM computer device, retrieved from an external service or database, retrieved from online or offline publications, or manually entered into the RPM computer device. In one example, rental listing data may be matched to rental data set based upon geographic region. In other words, rental listing data for a specific geographic region is matched to rental data set corresponding to the same geographic region. In other examples, rental data set also includes a rental location identifier. The rental location identifier may include, for example, a street address, a geographic coordinate identifier, and an alphanumeric listing which identifies a property within a rental property service including, for example, a multiple listing service (“MLS”). Accordingly, using the rental location identifier, rental property data set may be more precisely matched to rental listing data. In some embodiments, rental listing data may be included in the rental report.

In some embodiments, rental data sets are stored without including sensitive personal information, also known as personally identifiable information or PII, in order to ensure the privacy of individuals associated with the stored data. Personally identifiable information may include any information capable of identifying an individual including a tenant or a landlord. For privacy and security reasons, personally identifiable information may be withheld from the rental data sets. In some examples where privacy and security can otherwise be ensured, or where individuals consent, personally identifiable information may be retained in the rental data sets. In such examples, personally identifiable information may be needed to create enhanced financial assessments. In situations in which the systems discussed herein collect personal information about individuals including cardholders or merchants, or may make use of such personal information, the individuals may be provided with an opportunity to control whether such information is collected, or to control whether and/or how such information is used. In addition, certain data may be processed in one or more ways before it is stored or used, so that personally identifiable information is removed. For example, an individual's identity may be processed so that no personally identifiable information can be determined for the individual, or an individual's geographic location may be generalized where location data is obtained (such as to a city, ZIP code, or state level), so that a particular location of an individual cannot be determined. Thus, the individual may have control over how information is collected about the individual and used by systems including the RPM computer device.

In some further embodiments, the RPM computer device is able to create a rental data database. The rental data database includes a variety of rental data. In other words, the rental data database includes data associated with a variety of rental properties over a period of time and a range of geographic locations. The rental data database may be stored at the RPM computer device or alternately be in communication, such as networked communication, with the RPM computer device. The rental data database may be used for a variety of purposes including evaluating specific rental properties, categories of rental property, rental behavioral patterns, trends in rental pricing, rental pricing by geographic area. The RPM computer device may also receive further data which is integrated into the rental data database. In the example embodiment, the RPM computer device receives a plurality of rental listing data associated with a geographic region. The RPM computer device stores the plurality of rental listing data. In some examples, the RPM computer device may associate the rental listing data with the rental data sets. Accordingly, in such embodiments, the RPM computer device can access rental property data including actual rental data and rental listing data. The RPM computer device can determine differentials between actual rental data and rental listing data.

The methods and systems described herein may be implemented using computer programming or engineering techniques including computer software, firmware, hardware, or any combination or subset wherein a technical effect of the systems and processes described herein is achieved by performing at least one of the following steps: (a) receiving a plurality of transaction data associated with a plurality of payment transactions from a payment system; (b) scanning each payment transaction for the presence of at least one rental transaction indicator, wherein the at least one rental transaction indicator includes at least one of: a rental payee, a payment period indicating a rental payment, numerical characteristics of a rental payment, and a repeated pattern of payment; (c) determining, for each payment transaction, whether the payment transaction was a rental transaction based upon the presence of a rental transaction indicator; (d) storing each determined rental transactions as a rental data set, wherein each rental data set includes transaction data related to a rental transaction for a rental property, and wherein each rental data set further includes a rent amount paid, a rental location identifier, a payor identifier, and a landlord identifier; (e) generating, by the processor, a list of rental properties based on the rental location identifiers from one or more of rental data sets; (f) determining, by the processor, the rent amount paid for each rental property from the one or more rental data sets; and (g) generating, by the processor, a rental report based on the list of rental properties and the determined rent amount paid for each rental property, wherein the rental report includes at least one of a range of rental amounts paid for at least one rental property of the plurality of rental properties, a change of rental amounts paid over time for at least one rental property of the plurality of rental properties, rental amounts paid for at least one rental property of the plurality of rental properties, and a variance between an advertised rental amount and the rental amount paid for at least one rental property of the plurality of rental properties

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the evaluation of residential rental pricing.

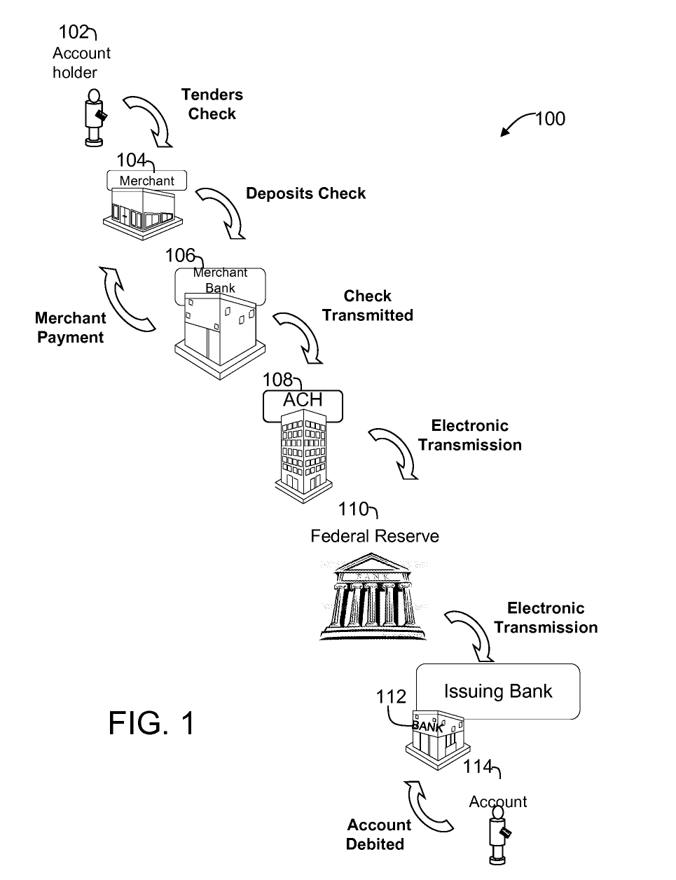

FIG. 1 is a schematic diagram illustrating an example multi-party check processing system 100 for enabling ordinary payment-by-check transactions in which an account holder 102 makes a check payment to a merchant 104 (also known as an originating merchant), and the check is drawn to an account issued by an issuing bank 112. A check, as used in such a payment transaction, is a form of a bill of exchange. A check is typically a written order from one person (the payor) to another (the payee), signed by the payor, and requiring the bank at which the payor holds a checking account to pay on demand or at some fixed future date, a certain sum of money, to either the person identified as payee or to any person presenting the check, such as the bank at which the payee holds an account. Checks can be either paper or electronic. A paper check is a physical written instrument. An electronic check (also known as an eCheck) is an electronic form of a paper check. An electronic check can be used and processed similarly to a paper check.

In one embodiment, the customer or account holder 102 pays a bill of sale at the merchant 104 using a paper check. In such a case, the customer 102 is considered the payor and the merchant 104 is the payee. Generally, the customer 102 also provides the merchant 104 with identification and/or contact information in case a check is returned as nonpayable. The merchant 104 then deposits the check to a merchant bank 106, which is a bank at which the merchant 104 holds an account. Typically, at the end of the business day, the merchant 104 deposits the check, along with all other checks received that day. After the merchant bank 106 posts the value of the check to the merchant's account, the merchant bank 106 sends the check to an automated clearing house (ACH) 108. One example of an automated clearing house 108 is the National Automated Clearing House Association (NACHA). The ACH 108 sorts all received checks according to the issuing bank 112, which is a bank at which the customer 102 holds an account 114. In the case of paper checks, the ACH 108 also scans each check to generate an electronic image and electronically transmits the electronic images to a Federal Reserve Bank 110. The ACH 108 also sends the paper checks to the issuing bank 112 associated with the account on which the check was drawn. The Federal Reserve Bank 110 receives the electronically transmitted check images from the ACH 108 and, in turn, electronically transmits the images to the issuing bank 112 associated with each check. The issuing bank 112 then debits the customer's account 114 held at the issuing bank 112 and transfers the check amount to the merchant bank 106.

In another embodiment, the customer or account holder 102 pays a bill of sale at a merchant 104 using an electronic check. The merchant 104 then transmits the electronic check to the ACH 108. The ACH 108 notifies the merchant bank 106 of the value of the check. The merchant bank 106 posts the value of the check to the merchant's account. The ACH 108 sorts all received checks according to the issuing bank 112. The ACH 108 transmits the electronic check to the Federal Reserve Bank 110. The Federal Reserve Bank 110 receives the electronic check from the ACH 108 and, in turn, transmits the electronic check to the issuing bank 112 associated with each check. The issuing bank 112 then debits the customer's account 114 held at the issuing bank 112 and transfers the check amount to the merchant bank 106.

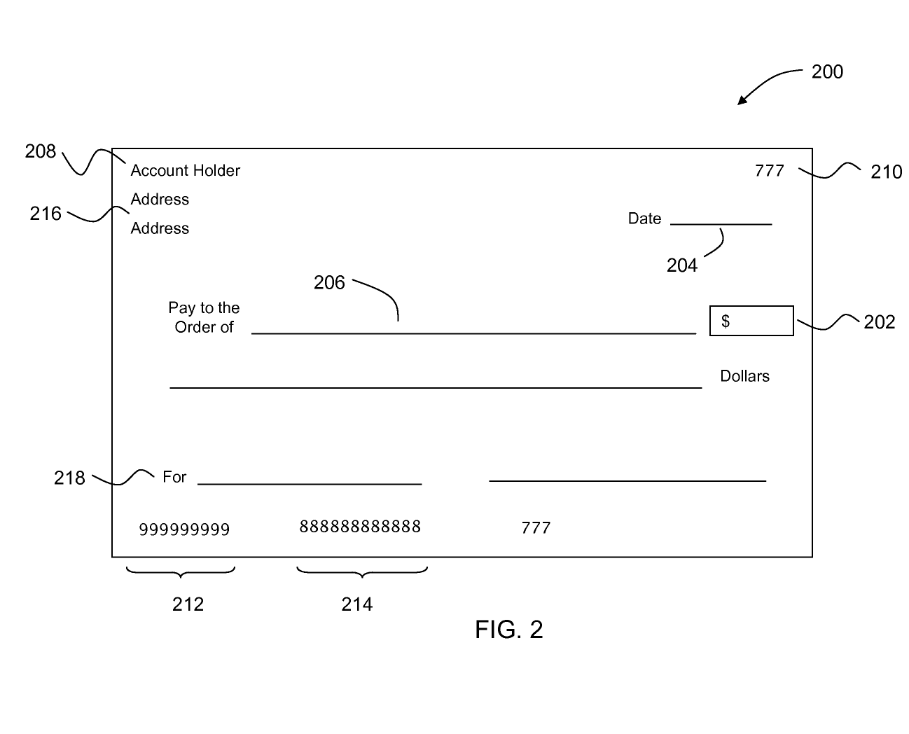

FIG. 2 is a schematic of a check 200 that may be used in a financial transaction, such as the transaction described in FIG. 1. Check 200 includes data relating to the transaction and data relating to the account on which check 200 is drawn. Transaction-related data includes, for example, a transaction amount 202, a transaction date 204, and a payee 206. Account-related data includes, for example, an account holder's name 208, a check number 210, an issuing bank routing number 212, and an account number 214. Routing number 212 and account number 214 are applied to check 200 using magnetic ink such that a Magnetic Ink Character Recognition (MICR) reader is enabled to read numbers 212 and 214 during the process described above and shown in FIG. 1. Further check 200 also includes an address field 216, which contains the address of the account holder, and a memo field 218 for notes from the account holder.

In some embodiments, when making a rental payment, the address in the address field 216 is the address that the rental payment is for. In other embodiments, a number of the rental property, such as a unit or apartment number, is included in the memo first 218.

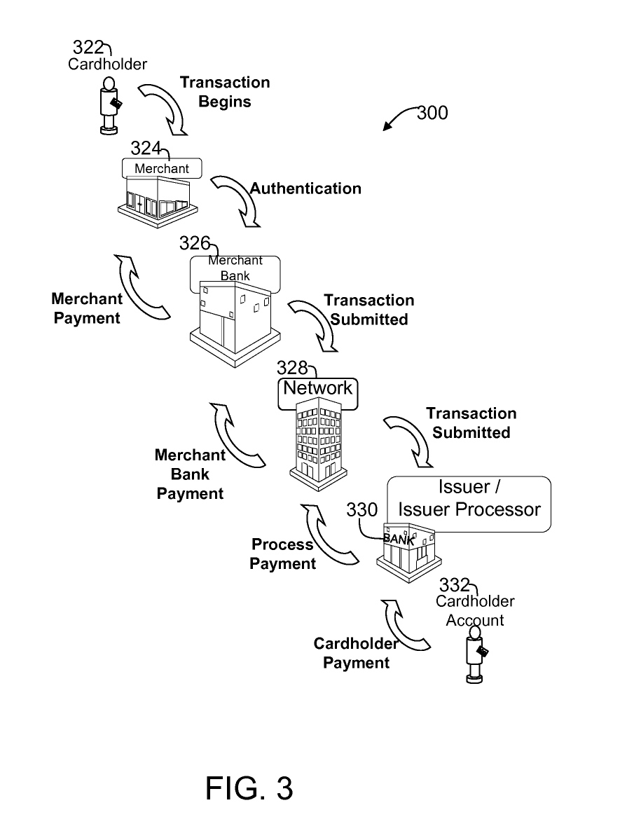

FIG. 3 is a schematic diagram illustrating an example multi-party transaction card processing system 300 for enabling ordinary payment-by-card transactions in which merchants 324 and card issuers 330 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 322, who uses the transaction card to tender payment for a purchase from a merchant 324 (also known as an originating merchant). To accept payment with the transaction card, merchant 324 must normally establish an account with a financial institution that is part of the financial payment system. This financial institution is usually called the “merchant bank,” the “acquiring bank,” or the “acquirer.” When cardholder 322 tenders payment for a purchase with a transaction card, merchant 324 requests authorization from a merchant bank 326 for the amount of the purchase. The request may be performed over the telephone, but is usually performed through the use of a point-of-sale terminal, which reads cardholder's 322 account information from a magnetic stripe, a chip, or embossed characters on the transaction card and communicates electronically with the transaction processing computers of merchant bank 326. Alternatively, merchant bank 326 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 328, computers of merchant bank 326 or merchant processor will communicate with computers of an issuer bank 330 to determine whether cardholder's account 332 is in good standing and whether the purchase is covered by cardholder's 322 available credit line. Based on these determinations, the request for authorization will be declined or accepted. If the request is accepted, an authorization code is issued to merchant 324.

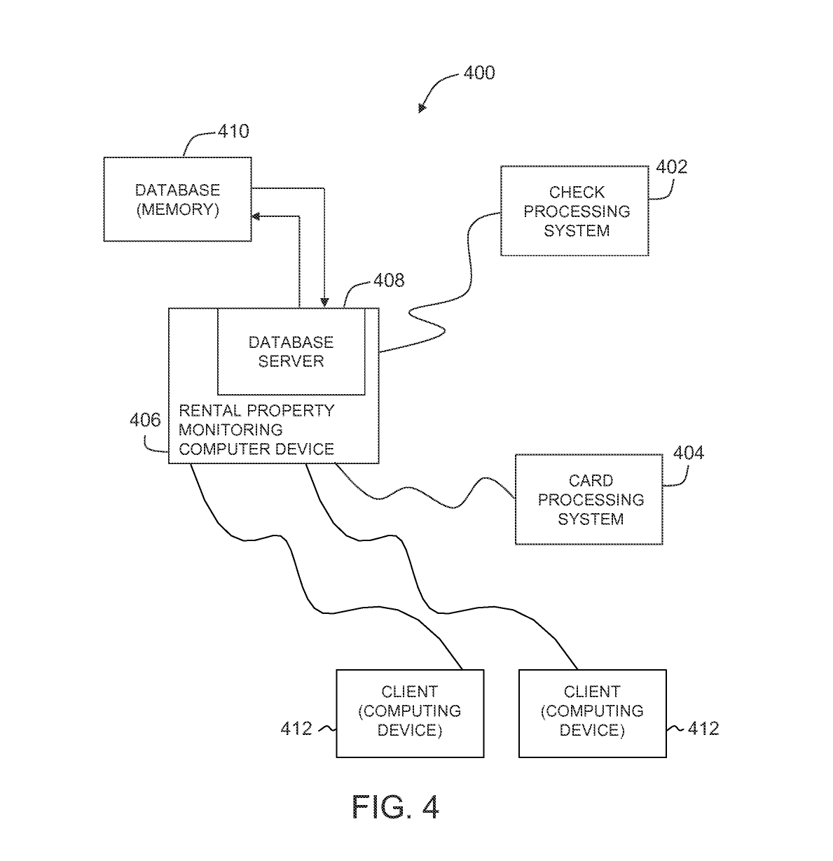

When a request for authorization is accepted, the available credit line of cardholder's account 332 is decreased. Normally, a charge for a payment card transaction is not posted immediately to cardholder's account 332 because bankcard associations, such as MasterCard International Incorporated®, have promulgated rules that do not allow merchant 324 to charge, or “capture,” a transaction until goods are shipped or services are delivered. However, with respect to at least some debit card transactions, a charge may be posted at the time of the transaction. When merchant 324 ships or delivers the goods or services, merchant 324 captures the transaction by, for example, appropriate data entry procedures on the point-of-sale terminal. This may include bundling of approved transactions daily for standard retail purchases. If cardholder 322 cancels a transaction before it is captured, a “void” is generated. If cardholder 322 returns goods after the transaction has been captured, a “credit” is generated. Interchange network 328 and/or issuer bank 330 stores the transaction card information, such as a category of merchant, a merchant identifier, a location where the transaction was completed, amount of purchase, date and time of transaction, in a database 410 (shown in FIG. 4).

After a purchase has been made, a clearing process occurs to transfer additional transaction data related to the purchase among the parties to the transaction, such as merchant bank 326, interchange network 328, and issuer bank 330. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 322 purchases travel, such as airfare, a hotel stay, and/or a rental car, at least partial itinerary information is transmitted during the clearance process as transaction data. When interchange network 328 receives the itinerary information, interchange network 328 routes the itinerary information to database 410.

For debit card transactions, when a request for a personal identification number (PIN) authorization is approved by the issuer, cardholder's account 332 is decreased. Normally, a charge is posted immediately to cardholder's account 332. The payment card association then transmits the approval to the acquiring processor for distribution of goods/services or information, or cash in the case of an automated teller machine (ATM).

After a transaction is authorized and cleared, the transaction is settled among merchant 324, merchant bank 326, and issuer bank 330. Settlement refers to the transfer of financial data or funds among merchant's 324 account, merchant bank 326, and issuer bank 330 related to the transaction. Usually, transactions are captured and accumulated into a “batch,” which is settled as a group. More specifically, a transaction is typically settled between issuer bank 330 and interchange network 328, and then between interchange network 328 and merchant bank 326, and then between merchant bank 326 and merchant 324.

FIG. 4 is a block diagram of an example payment processing system 400 used for determining the actual rent prices paid at different addresses in accordance with one example embodiment of the present disclosure. In the example embodiment, system 400 may be used for aggregating rental payments received from the check processing system 402 and the card processing system 404. In addition, system 400 is used for determining the actual rental prices paid for rental property and reporting the determined actual rental prices. System 400 includes a rental property monitoring (RPM) computer device 406.

A database server 408 is communicatively coupled to a database 410 that stores data. In one embodiment, database 410 includes transaction information from check processing system 402 and card processing system 404 and rental data sets determined from the transaction information. In the example embodiment, database 410 is stored remotely from RPM computer device 406. In some embodiments, database 410 is decentralized. In the example embodiment, a person can access database 410 via client systems 412 by logging onto RPM computer device 406, as described herein.

In the example embodiment, client systems 412 are computers that include a web browser or a software application, which enables client systems 412 to access RPM computer device 406 using the Internet. More specifically, client systems 412 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 412 can be any device capable of accessing the Internet including, but not limited to, a desktop computer, a laptop computer, a personal digital assistant (PDA), a cellular phone, a smartphone, a tablet, a phablet, or other web-based connectable equipment.

RPM computer device 406 is communicatively coupled with check processing system 402. Check processing system 402 may be check processing system 100 and be communicating with RPM computer device 406 through, for example, a computing device associated with ACH 108, the issuing bank 112, or the merchant bank 106, all shown in FIG. 1. In some embodiments, RPM computer device 406 is associated with, or is part of the check processing system 100. In other embodiments, RPM computer device 406 is associated with a third party and is merely in communication with the check processing system 100.

RPM computer device 406 is communicatively coupled with card processing system 404. Card processing system 404 may be payment card system payment network 300 and be communicating with RPM computer device 406 through, for example, a computing device associated with interchange network 328, the issuing bank 330, or the merchant bank 326, all shown in FIG. 3. In some embodiments, RPM computer device 406 may be associated with, or is part of the payment card system payment network 300. In other embodiments, RPM computer device 406 is associated with a third party and is merely in communication with payment card system payment network 300.

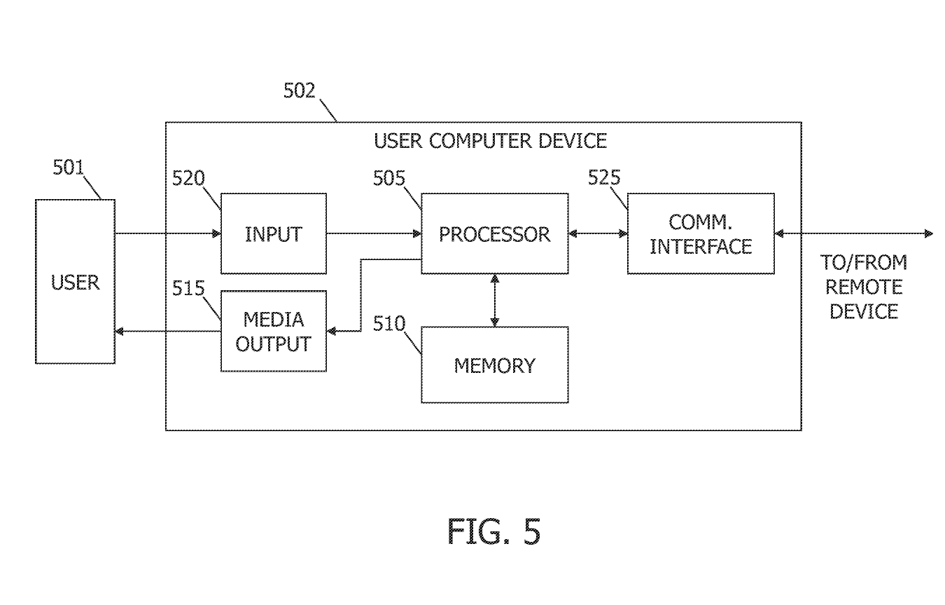

FIG. 5 illustrates an example configuration of a client system 412 shown in FIG. 4, in accordance with one embodiment of the present disclosure. User computer device 502 is operated by a user 501. User computer device 502 may be used to enter rental data into database 410 (shown in FIG. 4) or to retrieve the rental report. User computer device 502 may include, but is not limited to, client systems 412. User computer device 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or transaction data to be stored and retrieved. Memory area 510 may include one or more computer readable media.

User computer device 502 also includes at least one media output component 515 for presenting information to user 501. Media output component 515 is any component capable of conveying information to user 501. In some embodiments, media output component 515 includes an output adapter (not shown) such as a video adapter and/or an audio adapter. An output adapter is operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 515 is configured to present a graphical user interface (e.g., a web browser and/or a client application) to user 501. A graphical user interface may include, for example, an online store interface for viewing and/or purchasing items, and/or a wallet application for managing payment information. In some embodiments, user computer device 502 includes an input device 520 for receiving input from user 501. User 501 may use input device 520 to, without limitation, select and/or enter one or more items to purchase and/or a purchase request, or to access credential information, and/or payment information. Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as RPM computer device 406 (shown in FIG. 4). Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from RPM computer device 406. A client application allows user 501 to interact with, for example, RPM computer device 406. For example, instructions may be stored by a cloud service, and the output of the execution of the instructions sent to the media output component 515.

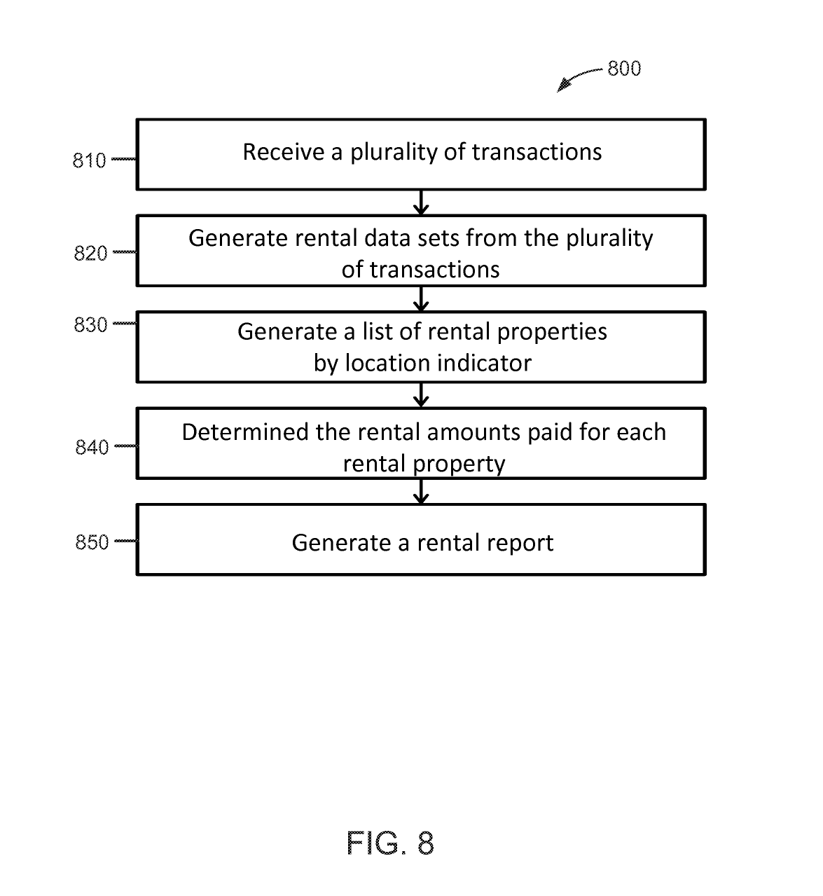

Processor 505 executes computer-executable instructions for implementing aspects of the disclosure. In some embodiments, the processor 505 is transformed into a special purpose microprocessor by executing computer-executable instructions or by otherwise being programmed. For example, the processor 505 is programmed with the instruction such as illustrated in FIG. 8.

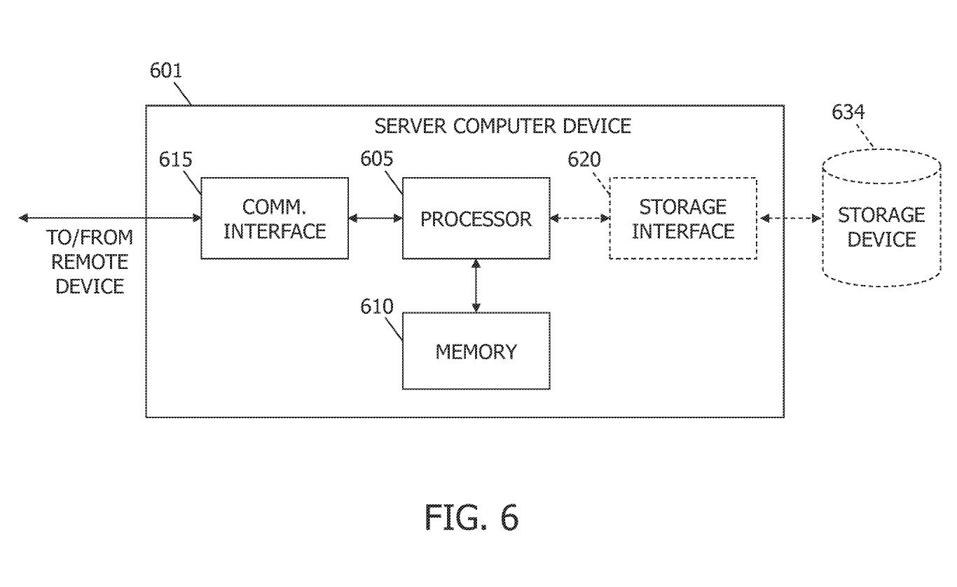

FIG. 6 illustrates an example configuration of the RPM computer device 406 shown in FIG. 4, in accordance with one embodiment of the present disclosure. Server computer device 601 may include, but is not limited to, database server 408 (shown in FIG. 4). Server computer device 601 also includes a processor 605 for executing instructions. Instructions may be stored in a memory area 610. Processor 605 may include one or more processing units (e.g., in a multi-core configuration).

Processor 605 is operatively coupled to a communication interface 615 such that server computer device 601 is capable of communicating with a remote device such as another server computer device 601 or client systems 412 (shown in FIG. 4). For example, communication interface 615 may receive requests from client systems 412 via the Internet, as illustrated in FIG. 4.

Processor 605 may also be operatively coupled to a storage device 634. Storage device 634 is any computer-operated hardware suitable for storing and/or retrieving data, such as, but not limited to, data associated with database 410 (shown in FIG. 4). In some embodiments, storage device 634 is integrated in server computer device 601. For example, server computer device 601 may include one or more hard disk drives as storage device 634. In other embodiments, storage device 634 is external to server computer device 601 and may be accessed by a plurality of server computer devices 601. For example, storage device 634 may include a storage area network (SAN), a network attached storage (NAS) system, and/or multiple storage units such as hard disks and/or solid state disks in a redundant array of inexpensive disks (RAID) configuration.

In some embodiments, processor 605 is operatively coupled to storage device 634 via a storage interface 620. Storage interface 620 is any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

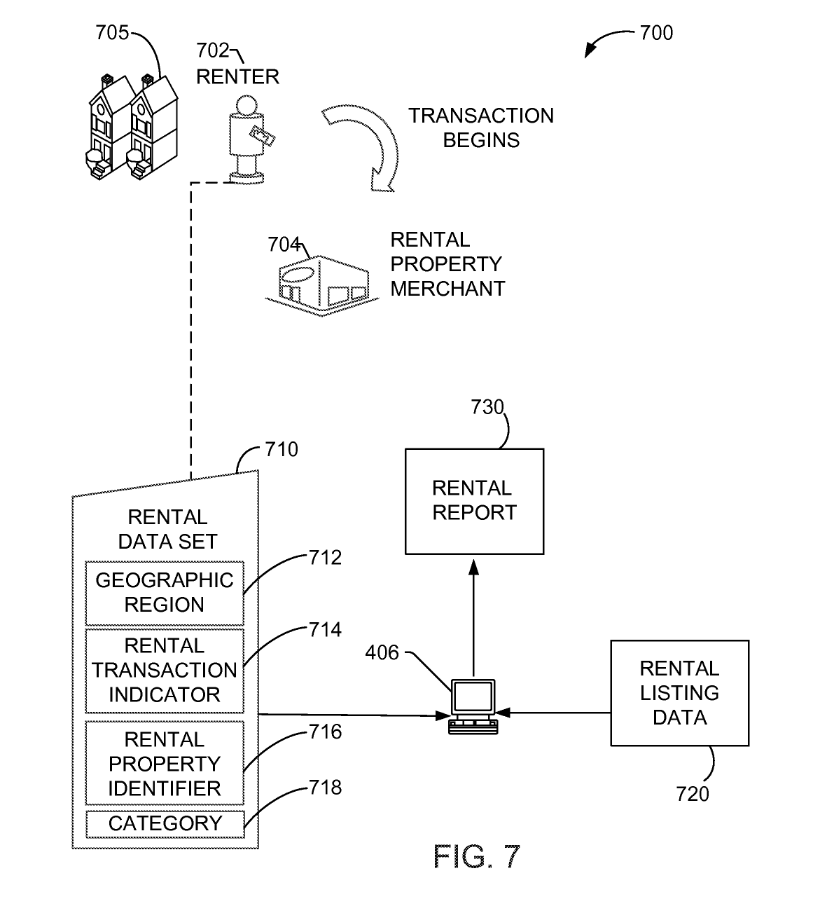

FIG. 7 is a simplified block diagram of an example embodiment of a system 700 for determining which transactions of a plurality of transactions received from the payment card processing system 404 and the check processing system 402 (both shown in FIG. 4) contain rental data. In the example embodiment, renter 702 is a tenant occupying rental property 705 and making a rental payment for rental property 705. Also, in the example embodiment, rental property 705 represents a unit in an apartment complex in a geographic region. Alternately, rental property 705 may be any rental property which is rentable by renter 702. Accordingly, renter 702 tenders payment in the form of a rental payment to rental property merchant 704, where rental property merchant 704 is a landlord or a property management company. Rental property merchant 704 may be identified in transaction data with a landlord identifier. The landlord identifier may reference an individual landlord or it may refer to a property management company that manages multiple rental properties, in other embodiments the landlord identifier may be a predefined alphanumeric code. Rental property merchant 704 may be merchant 104 (shown in FIG. 1) or merchant 324 (shown in FIG. 3). As described above, before or during the clearing process, transaction data related to the rental transaction is transferred among the parties processing the payment card or the check transaction, such as shown in FIGS. 1 and 3. Such transaction data includes rental data set 710. In the example embodiment, rental data set 710 includes a geographic region 712. Geographic region 712 may be any geographic identifier including, for example and without limitation, a postal code, a city/town/municipality, a neighborhood in a city/town/municipality, GPS coordinates, a county, a street address, a unit number, and sub-divisions of any of the preceding geographic identifiers. In the example embodiment, rental data set 710 for a transaction processed through payment card system 404 may include as follows (Table 1):

TABLE 1

| Transaction | Transaction | Transaction | Geographic | |
|---|---|---|---|---|
| Date | Time | Amount | Location | Merchant |
| Jan. 1, | 12:15 PM | $550.00 | Anytown | Property |
| 2014 | | | | Management |
| | | | | Services |
| | | | | ABC |

In the example embodiment, rental data set 710 for a transaction processed through check processing system 402 may be determined from the check 200 (shown in FIG. 2) itself. This includes the geographic region 712 which may be determined from the address field 216 and/or memo field 218 of the check 200 (all shown in FIG. 2). Rental data set 710 may also include transaction amount 202, transaction date 204, payee 206, and payor which may be determined from routing number 212, account number 214, and account holder's name 208.

RPM computer device 406 is configured to identify a particular transaction as a rental transaction to distinguish between received transaction data for paying rent and other transaction data. Accordingly, RPM computer device 406 is configured to identify a rental transaction indicator 714 to facilitate the identification of the rental transaction. Rental transaction indicator 714 is data that represents an identifying flag for identifying a transaction as a rental transaction that contains rental data sets 710. As described herein, rental data sets 710 and associated data are stored any appropriate storage device available to RPM computer device 406. In the example embodiment, RPM computer device 406 stores rental data sets 710 and associated data (e.g., rental listing data 720) at memory 610 (shown in FIG. 6). In alternative embodiments, RPM computer device 406 may store rental data sets 710 and associated data at storage device 634 (shown in FIG. 6) or any other appropriate storage device including a networked database in communication with RPM computer device 406 such as database 410 (shown in FIG. 4).

Rental transaction indicator 714 includes, for example and without limitation, a landlord indicator (also known as a rental payee), a payment period, numerical characteristics of a payment, and a repeated payment amount. A particular payee may be identified as a rental property merchant 704. In one example, RPM computer device 406 may include a database of known rental property merchants 704 renting rental property. In alternative examples, rental property merchant 704 may be listed in transaction data with data such as words or phrases indicating that rental property merchant 704 is a landlord including, for example, “Property Management”, “Property Services”, and “Landlord.” Payment period may also be a rental transaction indicator 714. If renter 702 makes a payment at or near the same date of the month for several months in succession and for a recurring amount, the transactions associated with such periodic payments may be noted as having rental transaction indicators 714 and may be identified as containing rental data sets 710. However, at least some additional transactions may be periodic and for a recurring amount but not be associated with rental transactions. For example, car payments may be paid at the same date every month. Car payments may be distinguished by the fact that the car payments lack numerical characteristics typical of rental property transactions. For example, rental transactions tend to be in round numbers (e.g. $500 per month) while car payments tend to have non-round numbers. To further illustrate the determination of rental transaction indicator 714 data below indicates both rental transactions and non-rental transactions (Table 2):

TABLE 2

| Transaction | Transaction | Transaction | Geographic | |
|---|---|---|---|---|
| Date | Time | Amount | Location | Merchant |
| (Jan. 1, | 12:15 PM | ($550.00) | Anytown | (Property |
| 2014) | | | | Management |
| | | | | Services ABC) |
| Jan. 9, | 2:44 PM | $25.35 | Anytown | ABC |
| 2014 | | | | Gas-N-Go |
| (Feb. 1, | 1:26 PM | ($550.00) | Anytown | (Property |
| 2014) | | | | Management |
| | | | | Services ABC) |
| Feb. 2, | 1:33 AM | $107.24 | Anytown | Molly's |
| 2014 | | | | Restaurant |
| (Mar. 1, | 3:26 PM | ($550.00) | Anytown | (Property |
| 2014) | | | | Management |
| | | | | Services ABC) |

Rental transaction indicators 714 are shown in Table 2 in parenthesis. Note that in Table 2, rental transaction indicators 714 are indicated based on payment period (rental payments are always made on the first of the month), numerical characteristics (rental payments are always for $550.00), and merchant identifiers (rental payments are made to “Property Management Services ABC.). In at least some cases, rental data sets 710 may deviate from some of these characteristics. Accordingly, RPM computer device 406 processes such deviating rental data sets 710 accordingly. The absence of a check is also a useful piece of information, as it can indicate that the renters are delinquent or have moved. For example, renter 702 may move out of rental property 705 in the middle of the month and only pay a partial payment for that month. Further in the last month of payment, renter 702 may receive a refund based on a security deposit refund. RPM computer device 406 may review the plurality of rental data sets 710 and determine that the last month is an outlier due to the payment being on a different date than normal, and being a different amount than normal. Further, after the final month, RPM computer device 406 may process rental data sets 710 and determine that no new rental data sets 710 have arrived. Accordingly, rental data set 710 for the last month may not be used to determine a financial assessment associated with rental property 705, as discussed below. However, rental data set 710 for the last month may be retained for other analysis and flagged as a, “move-out date.” Alternately, the last month may be removed from rental data set 710 because it represents an outlier.

In a second example, a first month's payment by renter 702 may be higher than normal due to security deposit payments. Similarly, as RPM computer device 406 receives recurring rental data sets 710 which deviate from the first month's payment, rental data set 710 for the first month may be retained for other analysis and flagged as a, “move-in date.” Alternately, RPM computer device 406 may remove rental data set 710 for the first month because it represents an outlier. In a third example, rental data set 710 may include utilities in a situation where rental property merchant 704 charges renter 702 for rent and utilities. RPM computer device 406 may accordingly average the rent in rental data set 710 to flatten the data. In a fourth example, rental data set 710 may indicate a change in rent. For example, twelve successive rental data sets 710 associated with renter 702 and rental property merchant 704 may indicate payment in the amount of “$550.00” while the next three successive rental data sets 710 may indicate payment in the amount of “$575.00.” In the example embodiment, RPM computer device 406 is configured to wait for a predetermined amount of intervals before determining that a rental price has changed. In the example embodiment, RPM computer device 406 waits for three months before confirming a rental price change. In other embodiments, RPM computer device 406 may wait for shorter or longer intervals, or another prescribed time period, or receive user or external input to confirm a rental price change. Additionally, multiple move-in and move-out dates may indicate a high turnover rate for the rental property. The high turnover rate may indicate that re-renting the unit may be expensive since the landlord will need to paint, replace or clean the carpets, and potentially replace appliances.

As described above, over a period of time, RPM computer device 406 may receive a plurality of rental data sets 710 related to renter 702 renting rental property 705. Accordingly, the plurality of rental data sets 710 may include data reflecting the history of the tenancy of renter 702 with rental property 705. Such history may indicate trends including, for example, move-in dates, move-out dates, and rental increases. In the example embodiment, RPM computer device 406 stores rental data sets 710 without including any protected personal information. Personally identifiable information is information that can be used on its own or with other information to identify, contact, or locate a single person, or to identify an individual in context. Accordingly, information which can identify renter 702 is not stored at RPM computer device 406. In alternative embodiments, personally identifiable information may be otherwise safeguarded by the policies of systems using rental data sets 710. In such alternative embodiments, personally identifiable information may be available to assist in determining additional information regarding rental property 705, for example if the individual consents to his PII being available.

RPM computer device 406 also receives rental listing data 720. Rental listing data 720 represents publically available data for rental property properties such as rental property 705. Rental property listing data 720 may also include, for example and without limitation, an advertised rental amount, a property tax associated with rental property 705, an advertised square footage associated with rental property 705, a physical layout associated with rental property 705, a number of units rented/available associated with rental property 705, and service and maintenance records associated with rental property 705. Rental listing data 720 may be stored in a database accessible to RPM computer device 406, retrieved from an external service or database, retrieved from online or offline publications, or manually entered into RPM computer device 406. In one example rental listing data 720 may be matched to rental data set 710 based upon geographic region 712. For example, rental listing data 720 for a specific geographic region 712 is matched to rental data set 710 corresponding to the same geographic region 712. In other examples, rental data set 710 also includes rental location identifier 716. Rental location identifier 716 may include, for example, a street address, a geographic coordinate identifier, and an alphanumeric listing which identifies a property within a rental property service including, for example, a multiple listing service (“MLS”). Accordingly, using rental location identifier 716, rental property data set 710 may be more precisely matched to rental listing data 720.

Rental property data set 710 additionally includes rental property category 718. Rental property category 718 identifies rental property 705 within a type of rental property including, for example and without limitation, apartments, single family houses, multi-family houses, duplexes, and quadplexes or the like. In some examples, rental property data set 710 and rental listing data 720 are processed to determine a valuation of rental property 705. In such examples, RPM computer device 406 stores the present valuation of rental property 705 with rental property data set 710.

In some embodiments, RPM computer device 406 processes rental property data sets 710 and rental listing data 720 to generate a rental report 730. In other embodiments, RPM computer device 406 just processes rental property data sets 710 to generate the rental report. The rental report may include a rent amount paid, a payor identifier, a geographic region of the rental property, a rental location identifier for the rental property, a landlord identifier, an advertised rental amount, an advertised square footage, and a rental period. In some embodiments, the rental report may also provide a range of rental amounts paid for the rental property, a change of rental amounts paid over time for the rental property, a turnover rate for at least one rental property of the plurality of rental properties, rental amounts paid for each of the plurality of rental properties, and a variance between an advertised rental amount and the rental amount paid for the rental property.

The rental report may be segregated by individual apartment or aggregated into a single report for all apartments within a single building street address. In some cases, the rental report may not include transaction data (i.e. rent amount paid, and payor identifier) for each rental unit in a rental property due to a lack of transaction data for that particular unit. Certain rental property buildings may also include multiple different sizes and or styles of units. For these reasons, the rental report may be segregated to show data for individual apartments, for different sizes or styles of apartments, or show ranges of rent amounts paid for those units within a rental property building.

FIG. 8 is a flowchart of an example process 800 for determining the actual rental prices of rental properties implemented using the payment processing system 400 and the RPM computer device 406 (both shown in FIG. 4) in accordance with one embodiment of the disclosure. RPM computer device 406 receives 810 a plurality of transactions. The transactions may be for check transactions processed through check processing system 402 or for payment card transactions processed through payment card system 404 (both shown in FIG. 4). RPM computer device 406 generates 820 rental data sets 710 (shown in FIG. 7) from the plurality of received transactions. From the rental data sets 710, RPM computer device 406 generates 830 a list of rental properties by rental location identifier. The rental location identifier may be the street address of the rental property or the address may include the unit number or apartment number. For each rental location identifier on the generated list, RPM computer device 406 determines 840 the rental amounts paid for the corresponding rental property. Then, RPM computer device 406 generates a rental report 730 (shown in FIG. 7) based on the list of rental properties and the rental amounts paid.

In some embodiment, a publically available list of rental properties is generated from publically available data, such as city ordinances and rental listings on the Internet. In this embodiment, RPM computer device 406 compares the advertised addresses from the publically available list of rental properties generated from publically available data with the processed addresses provided in the transaction data. Based on the comparison, RPM computer device 406 generates the transaction list of rental properties by address.

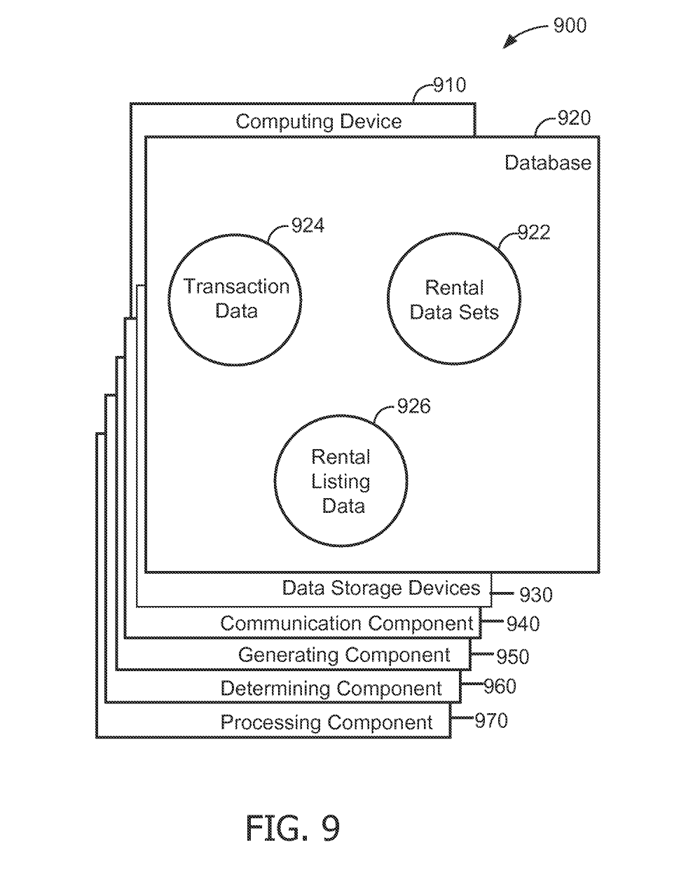

FIG. 9 is a diagram 900 of components of one or more example computing devices that may be used in the system 400 shown in FIG. 4. In some embodiments, computing device 910 is similar to RPM computer device 406 (shown in FIG. 4). Database 920 may be coupled with several separate components within computing device 910, which perform specific tasks. In this embodiment, database 920 includes rental data sets 922, which may be similar to rental data sets 710, transaction data 924, and rental listing data 926, which may be similar to rental listing data 720. In some embodiments, database 920 is similar to database 410 (shown in FIG. 4).

Computing device 910 includes the database 920, as well as data storage devices 930. Computing device 910 also includes a communication component 940 for receiving transaction from check processing system 402 and payment card processing system 404 (both shown in FIG. 4) and for receiving rental listing data 926 from client system 412 (shown in FIG. 4). Computing device 910 also includes a generating component 950 for generating rental data sets 922 from transactions, for generating a list of rental properties by address, and for generating a rental report. A determining component 960 is also included for determining the rental amounts paid for each rental property 705 (shown in FIG. 7). A processing component 970 assists with execution of computer-executable instructions associated with the system.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for determining actual pricing data for rental properties, said method using a computing device having a processor communicatively coupled to a memory, said method comprising:
receiving, by the processor, rental transaction data from a payment system, wherein the rental transaction data includes a plurality of payment transactions;
generating, by the processor, one or more rental data sets, wherein each rental data set includes a rent amount paid, a rental location identifier, a payor identifier, and a landlord identifier;
generating, by the processor, a list of rental properties based on the rental location identifiers from the one or more rental data sets;
determining, by the processor, the rent amounts paid for each rental property from the one or more rental data sets; and
generating, by the processor, a rental report based on the list of rental properties and the determined rent amount paid for each rental property.

2. The method in accordance with claim 1, wherein generating a one or more rental data sets further comprises:
determining, for each payment transaction, whether the payment transaction was a rental transaction based upon the presence of a rental transaction indicator; and
storing each of the rental transactions as a rental data set.

3. The method of claim 2 wherein determining whether the payment transaction was a rental transaction further comprises:
scanning the payment transaction for the presence of at least one rental transaction indicator, wherein the at least one rental transaction indicator includes at least one of:
a landlord identifier;
a payment period indicating a rental payment;
numerical characteristics of a rental payment; and
a repeated pattern of payment.

4. The method in accordance with claim 1, wherein the payment system is a check processing system and the payment transaction identifies a transaction for a check payment to an originating merchant.

5. The method in accordance with claim 1, wherein the payment system is a payment card processing system and the payment transaction identifies a transaction for a payment card payment at an originating merchant.

6. The method in accordance with claim 1, wherein generating a list of rental properties further comprising:
receiving, by the processor, a plurality of rental listing data, wherein the plurality of rental listing data includes at least one of an advertised rental amount, a property tax associated with rental property, an advertised square footage associated with rental property, a physical layout associated with rental property, a number of units rented/available associated with rental property, and service and maintenance records associated with rental property;
storing, in the memory, the plurality of rental listing data;
comparing, by the processor, the plurality of rental listing data and the rental location identifiers from the one or more rental data sets; and
generating, by the processor, the list of rental properties based the comparison.

7. The method of claim 6, wherein the rental report includes at least one of:
a range of rental amounts paid for at least one rental property of the plurality of rental properties;
a change of rental amounts paid over time for at least one rental property of the plurality of rental properties;
a turnover rate for at least one rental property of the plurality of rental properties;
rental amounts paid for at least one rental property of the plurality of rental properties; and
a variance between an advertised rental amount and the rental amount paid for at least one rental property of the plurality of rental properties.

8. A computing device for determining actual pricing data for rental properties, said computing device comprising one or more processors communicatively coupled to one or more memory devices, said computing device configured to:
receive rental transaction data from a payment system, wherein the rental transaction data includes a plurality of payment transactions;
generate a one or more rental data sets, wherein each rental data set includes a rent amount paid, a rental location identifier, a payor identifier, and a landlord identifier;
generate a list of rental properties based on the rental location identifiers from the one or more rental data sets;
determine the rent amounts paid for each rental property from the one or more rental data sets; and
generate a rental report based on the list of rental properties and the determined rent amount paid for each rental property.

9. The computing device of claim 8 further configured to:
determine, for each payment transaction, whether the payment transaction was a rental transaction based upon the presence of a rental transaction indicator; and
store each of the rental transactions as a rental data set.

10. The computing device of claim 9 further configured to:
scan the payment transaction for the presence of at least one rental transaction indicator, wherein the at least one rental transaction indicator includes at least one of:
a landlord identifier;
a payment period indicating a rental payment;
numerical characteristics of a rental payment; and
a repeated pattern of payment.

11. The computing device of claim 8, wherein the payment system is a check processing system and the payment transaction identifies a transaction for a check payment to an originating merchant.

12. The computing device of claim 8, wherein the payment system is a payment card processing system and the payment transaction identifies a transaction for a payment card payment at an originating merchant.

13. The computing device of claim 8 further configured to:
receive a plurality of rental listing data, wherein the plurality of rental listing data includes at least one of an advertised rental amount, a property tax associated with rental property, an advertised square footage associated with rental property, a physical layout associated with rental property, a number of units rented/available associated with rental property, and service and maintenance records associated with rental property;
store the plurality of rental listing data;
compare the plurality of rental listing data and the rental location identifiers from the one or more rental data sets; and
generate the list of rental properties based the comparison.

14. The computing device of claim 8, wherein the rental report includes at least one of:
a range of rental amounts paid for at least one rental property of the plurality of rental properties;
a change of rental amounts paid over time for at least one rental property of the plurality of rental properties;
a turnover rate for at least one rental property of the plurality of rental properties;
rental amounts paid for at least one rental property of the plurality of rental properties; and
a variance between an advertised rental amount and the rental amount paid for at least one rental property of the plurality of rental properties.

15. A computer-readable storage medium having computer-executable instructions embodied thereon, wherein when executed by a computing device having at least one processor coupled to at least one memory device, the computer-executable instructions cause the processor to:
receive rental transaction data from a payment system, wherein the rental transaction data includes a plurality of payment transactions;
generate a one or more rental data sets, wherein each rental data set includes a rent amount paid, a rental location identifier, a payor identifier, and a landlord identifier;
generate a list of rental properties based on the rental location identifiers from the one or more rental data sets;
determine the rent amounts paid for each rental property from the one or more rental data sets; and
generate a rental report based on the list of rental properties and the determined rent amount paid for each rental property.

16. The computer-readable storage medium of claim 15, wherein the computer-executable instructions further cause the processor to:
determine, for each payment transaction, whether the payment transaction was a rental transaction based upon the presence of a rental transaction indicator; and
store each of the rental transactions as a rental data set.

17. The computer-readable storage medium of claim 16, wherein the computer-executable instructions further cause the processor to:
scan the payment transaction for the presence of at least one rental transaction indicator, wherein the at least one rental transaction indicator includes at least one of:
a landlord identifier;
a payment period indicating a rental payment;
numerical characteristics of a rental payment; and
a repeated pattern of payment.

18. The computer-readable storage medium of claim 15, wherein the payment system is a check processing system and the payment transaction identifies a transaction for a check payment to an originating merchant.

19. The computer-readable storage medium of claim 15, wherein the payment system is a payment card processing system and the payment transaction identifies a transaction for a payment card payment at an originating merchant.

20. The computer-readable storage medium of claim 15, wherein the computer-executable instructions further cause the processor to:
receive a plurality of rental listing data, wherein the plurality of rental listing data includes at least one of an advertised rental amount, a property tax associated with rental property, an advertised square footage associated with rental property, a physical layout associated with rental property, a number of units rented/available associated with rental property, and service and maintenance records associated with rental property;
store the plurality of rental listing data;
compare the plurality of rental listing data and the rental location identifiers from the one or more rental data sets; and
generate the list of rental properties based the comparison
